(19) United States
(12) Patent Application Publication
(10) Pub. No.: US 2005/0057649 A1
(43) Pub. Date: Mar. 17, 2005

(54) Surveillance system responsive to lockset operation

(76) Inventor: George R. Marks, North Hills, NY (US)

Correspondence Address: LEVINE & MANDELBAUM, 444 MADISON AVENUE, 35TH FLOOR, NEW YORK, NY, 10022, US

(21) Appl. No.: 10/935,062

(22) Filed: Sep. 7, 2004

Related U.S. Application Data
(60) Provisional application No. 60/502,479, filed on Sep. 12, 2003.

(51) Int. Cl. H04N 7/18

(52) U.S. Cl. 348/143

(57) ABSTRACT

A surveillance system for monitoring a secure area having an entry door, the door being furnished with a lockset which normally keeps the door locked, and the lockset being responsive to an “authorization action” of a user to permit opening of the door. The “authorization action” may be punching a code into a keypad, presenting a coded card to a reader, operating the handle of the lockset, or other manipulations needed to open the locked door. A transmitter associated with the lockset issues a wireless signal each time the lockset responds to an authorization action of a user. A camera is arranged to take an image of the user at the door. A receiver receives the wireless signal from the transmitter and in response thereto triggers the camera to take an image of the user. The transmitter may be in circuit with a switch which is closed in response to movement of the door-unlatching mechanism, the switch completing a circuit for actuating the transmitter.

This invention relates to security systems, and more particularly to camera surveillance at the entry point of a secure area.

Secure areas are often accessible only through a locked door which can be opened only by authorized personnel. In a typical case, an authorized person is given one or more of a key, a card carrying a code which can be presented to a card reader, or a code to be punched into a keypad, so that the locked door to the secure area can be opened. The locked door is often provided with a lockset including a latch and a rotatable handle, the latch being retractable by rotation of the handle. In the usual case, when the door is locked, the latch cannot be retracted. However, when a correct code is punched into a keypad, or an authorized card swiped through the mechanism, the handle is permitted to rotate so as to retract the latch. Alternatively, when a key is inserted into a slot in the lockset, rotation of the key causes the latch to retract and permit opening of the door.

In some instances, it would be desirable to have a picture of each person who opens the door and thereby gains access to the secure area. For example, if a key, code, or card fall into the hands of an unauthorized person, without surveillance it would not be possible to know whether the unauthorized person gained entry into the secure area or whether the actual owner of the key, code, or card was the person who entered. This problem is solved by recording an image of each person who operates the door to gain entry.

While many surveillance cameras continuously watch a particular location, and can even provide a continuous recording of the image viewed at that location, in many instances such a continuous record is not practical or needed. What is needed is a system wherein a camera operates to record an image only for the short period of time that a person performs an “authorization action” at a secure door. The term “authorization action” refers to any one of swiping a card, punching a code into a keypad, or operating a lockset to open the door to a secure area. While momentary operation of the camera will usually be sufficient, the camera may be programmed to operate for additional time periods. It is an object of the present invention to provide such a system which can be furnished economically.

In general, camera surveillance systems are, in themselves, relatively inexpensive. However, such systems, initiated by locksets or other devices, usually involve relatively high installation costs. The reason is that wires must be run from the door to be watched to a camera usually remote from the door, and further wires must be run from the camera to a device for recording or displaying the images. Thus, such an installation involves removing and drilling the door, opening and closing walls to run the wires or cables (with attendant plastering and painting), and long runs of the cables in walls and ceilings to interconnect the door, camera, and recording device.

It is a primary object of the present invention to provide a camera surveillance system which eliminates most of these installation costs, thereby making the cost of installation minimal.

It is another object of the invention to provide such a system wherein each time the lockset is manipulated to open the door, or some other authorization action is taken, a wireless signal is sent to a camera causing the latter to record an image of the person who opened the door.

Each image could be recorded within the camera, or within a recording device connected to the camera. However, preferably a wireless internet camera is employed capable of transmitting the image, via the internet, to a computer in which the image is stored. Once the image is on the internet, it could be received and stored in devices other than computers, such as a Palm pilot, certain cell phones, and like devices. When an image is so stored, it can be transmitted, via e-mail, to another person for verification.

The invention will be further described with reference to the accompanying drawings, in which:

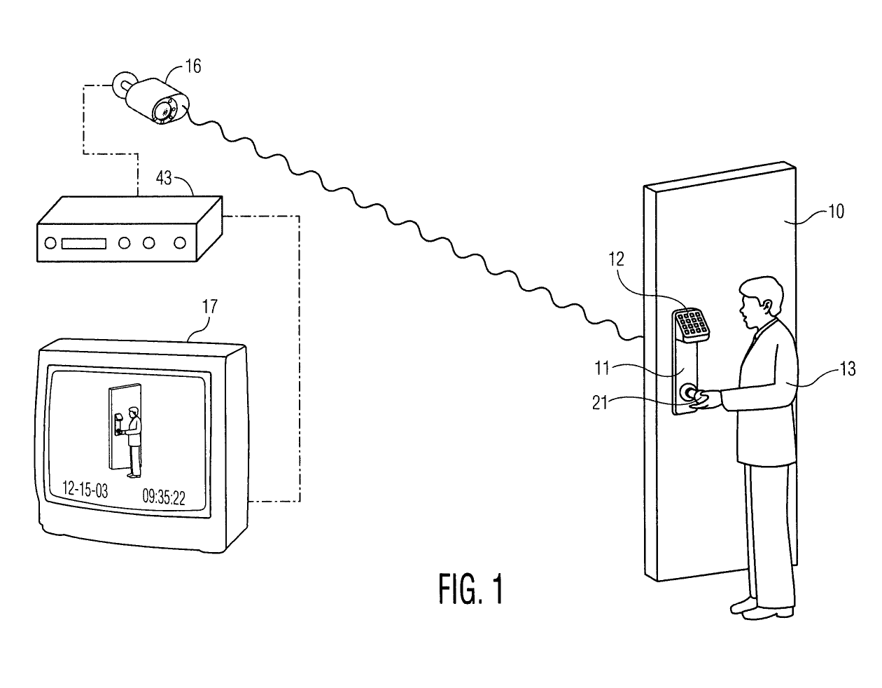

FIG. 1 is a schematic illustration of a person at the door of a secure area, as well as a camera and image display device at a remote location from the door;

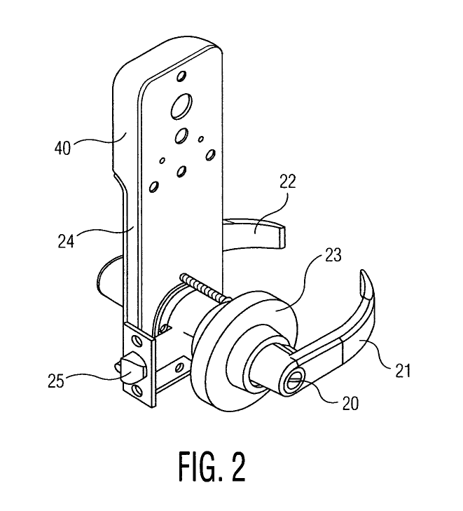

FIG. 2 is a perspective view of a part of a lockset according to this invention;

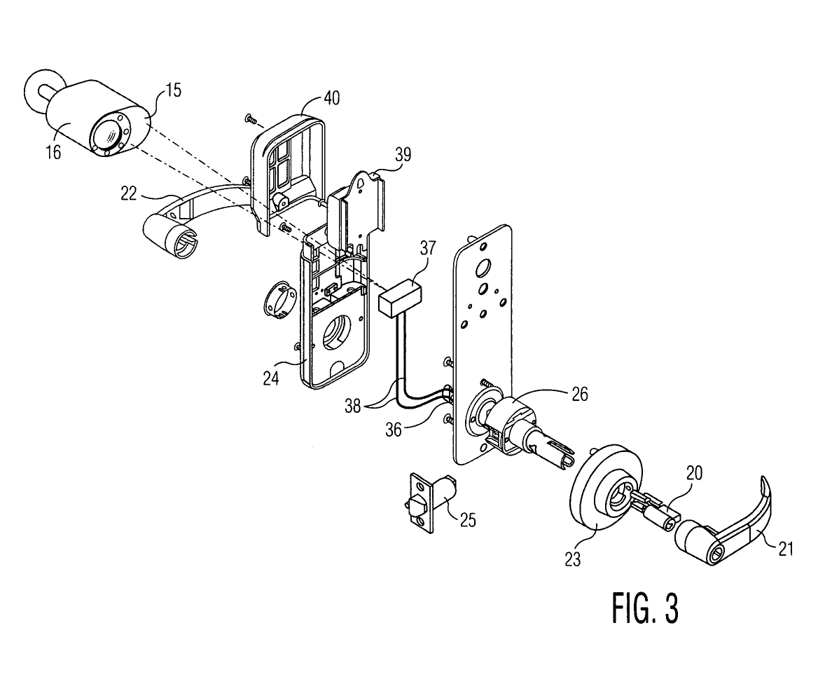

FIG. 3 is an exploded perspective view of the lockset of FIG. 2 and schematically illustrating the remote camera;

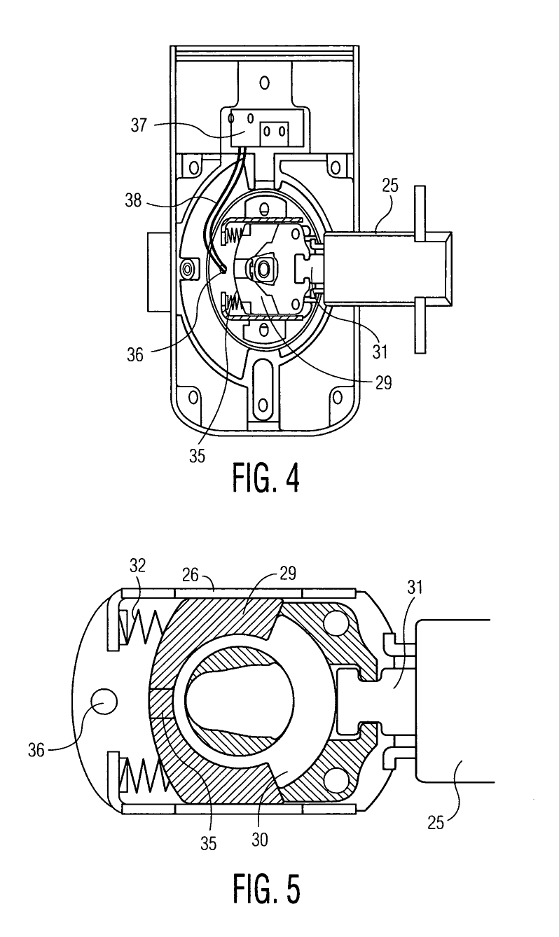

FIG. 4 is a cross-sectional view through the lockset at the location of the retractable latch; and

FIG. 5 is a cross-sectional view, on an enlarged scale, of a portion of FIG. 4.

An illustrative embodiment of the invention, shown in FIG. 1, includes a door 10 to a secure area furnished with an electronic lockset 11 of the type having a keypad 12. A person 13, having an authorized code, punches that code into the keypad, thereby permitting the handle 14 of the lockset to be rotated so as to unlatch the door. This “authorization action” by user 13 causes a wireless signal to be sent by a transmitter in the lockset to a receiver 15 (see FIG. 3) associated with a camera 16 located remotely from the door 10. The camera is positioned to take an image of the person 13 operating the lockset.

The image may be stored in the camera and retrieved from the camera, when needed. Alternatively, the image may be transmitted, preferably wirelessly, to a remote storage and display device, such as a computer 17.

A representative lockset is illustrated in more detail in FIGS. 2 and 3. In these figures, the keypad 12 and its associated mechanism is not shown, for the sake of clarity. It may be mentioned that instead of a keypad, the lockset could include a coded card reader to which a coded card is presented, such as by swiping the card through a slot associated with the reader, or any other type of identification scanner so as to limit access through the door only to authorized personnel. The lockset may also be operated by means of a key, which is inserted into a lock cylinder 20. The lockset includes an outside handle 21, which accommodates lock cylinder 20, an inside handle 22, outside trim 23 and an inside housing 24. The lockset also includes a retractable latch 25 and a latch actuator 26.

The latch actuator, shown in more detail in FIGS. 4 and 5, includes a slideable latch retractor 29 within which is a tube 30 which rotates with handle 21. Captured within retractor 29 is the tail 31 of latch 25. Upon rotation of tube 30, by handle 21, retractor 29 slides to the right, in FIG. 5, against the force of springs 32. As a result, latch 25 is pulled to the right and withdrawn from the door jamb into the door, allowing the door to be swung open.

Referring to FIG. 5, according to one embodiment of the present invention, the retractor 29 is furnished with a permanent magnet 35. Mounted within the lock body, close to the path of movement of magnet 35, is a normally-open reed switch 36. Each time handle 21 is rotated, retractor 29 slides in response, thereby sweeping magnet 35 past reed switch 36, causing the reed switch to close. Handle 21 can be rotated, to retract latch 25, when an authorized code is punched into keypad 12, or an authorized card is moved past a sensor, or some other authorization mode is properly employed, e.g., a biometric reader. Alternatively, retractor 29 can be rotated by a key inserted into lock cylinder 20 so as to retract latch 25.

While a magnet and reed switch have been shown for sensing rotation of the retractor, other means for sensing operation of the lockset could be employed. For example, a microswitch could be located within the lockset assembly for actuation by a part which moves when the latch is retracted.

The lockset is also outfitted, according to the present invention, with a radio frequency transmitter 37 (FIGS. 3 and 4) connected by wires 38 to reed switch 36, so that the transmitter issues a signal each time reed switch 21 is closed. Transmitter 37, and batteries 39 for operating it, are accommodated within inside housing 24, a separate cover 40 cooperating with housing 24 for enclosing the batteries.

The RF transmitter 37 (FIGS. 3 and 4) may be part of a UHF relay switch, which also includes the RF receiver 15. An appropriate relay switch could be a Catalog No. 3082, 2-channel UHF relay switch, made by Quasar Electronics, Ltd. of Bishop's Stortford, United Kingdom.

The RF receiver 15 is fitted to the camera 16 mounted to capture images of persons opening the door being subjected to surveillance. While any appropriate camera for the purpose may be employed, preferably, a wireless network internet camera is used as part of the present security surveillance system. Such a camera may be a Model BCS-1000W sold by D-Link Systems, Inc. of Irvine, Calif. The RF receiver 15 may be mounted adjacent to the camera 16 and wired to the triggered input of the camera so as to cause the camera to make a recording each time the door is opened.

A wireless router 43, such as D-link Model No. DI-614+, may be furnished to transmit wireless signals from the camera to the internet. If more than one secure area is to be monitored, each by a separate camera, the router 43 can be used to transmit wireless signals from all the cameras to the internet.

Thus, each time retractor 29 of the lockset is moved to retract latch 25, either by rotation of handle 21 or rotation of a key in lock cylinder 20, magnet 35 carried by retractor 29 causes reed switch 36 to close. Closing of the reed switch completes a circuit including the transmitter and the batteries, thereby causing the RF transmitter 37 mounted within the lockset to transmit a wireless signal to RF receiver 15 for triggering camera 16, which may be a wireless network internet camera. When the camera is triggered, an image is taken of the person opening the door by operating the lockset. This image is transmitted; usually through router 43, to the internet from which it may be picked up and stored in a computer 17 or like device.

Where the door being monitored contains an electronic lockset, authorized operation of a keypad or use of a card with a magnetic strip or an internal circuit, or operation of any other type of electronic authorization mode, causes an electrical signal to be sent via an electrical conductor to a motor (not shown) in the lockset. Operation of the motor causes a mechanical connection to be established between the door handle 21 and the latch mechanism, so that movement of the handle retracts the latch 25. This same electrical signal could be used, such as by sending it via an electrical conductor in parallel with the conductor to the motor, to activate the RF transmitter 37 to ultimately trigger the camera 16 through the RF receiver 15. In other words, this signal would be used in place of the signal produced by closing the reed switch.

The invention has been shown and described in preferred form only, and by way of example, and many variations may be made in the invention which will still be comprised within its spirit. It is understood, therefore, that the invention is not limited to any specific form or embodiment except insofar as such limitations are included in the appended claims.

1. A surveillance system for monitoring a secure area having an entry door, the door being furnished with a lockset which normally keeps the door locked, and the lockset being responsive to an authorization action of a user to permit opening of the door, the system comprising:
a transmitter associated with the lockset for issuing a wireless signal each time the lockset responds to an authorization action of a user,
a camera arranged to take an image of a user at the door, and
a receiver for receiving the wireless signal from the transmitter and in response thereto triggering the camera to take an image of the user.

2. A surveillance system as defined in claim 1 wherein the camera is remote from the door.

3. A surveillance system as defined in claim 1 wherein the signal issued by the transmitter, and received by the receiver, is a radio frequency signal.

4. A surveillance system as defined in claim 1 wherein the receiver produces an output signal, and means for transmitting the output signal to the triggered input of the camera.

5. A surveillance system as defined in claim 1 wherein the image taken by the camera is stored in the camera.

6. A surveillance system as defined in claim 1 wherein the camera includes means for transmitting the image to a display device remote from the camera.

7. A surveillance system as defined in claim 1 wherein the camera is a wireless network internet camera, and including a wireless router for transmitting wireless signals, representing the image, to the internet.

8. A surveillance system as defined in claim 1 wherein the lockset is provided with a keypad, and the authorization action is punching a code into the keypad.

9. A surveillance system as defined in claim 1 wherein the lockset is provided with a coded card reader, and the authorization action is presenting a coded card to the reader.

10. A surveillance system as defined in claim 1 wherein the lockset includes a movable handle, and a latch retractable is response to movement of the handle, and the authorization action is moving the handle to retract the latch.

11. A surveillance system as defined in claim 10 wherein the lockset includes a switch in circuit with the transmitter, the switch responding to movement of the handle for closing the circuit to operate the transmitter.

12. A surveillance system as defined in claim 10 wherein the lockset includes a latch retractor movable in response to movement of the handle, and a switch in circuit with the transmitter, the switch responding to movement of the latch retractor for closing the circuit to operate the transmitter.

13. A surveillance system as defined in claim 12 wherein the switch is a magnetically responsive switch, and the latch retractor carries a magnet for operating the switch when the latch retractor moves in response to movement of the handle.

14. A surveillance system as defined in claim 1 wherein the lockset includes means for producing an electrical signal in response to an authorization action of a user, and means for actuating the transmitter in response to the electrical signal.

15. A surveillance system for monitoring a secure area having an entry door, the door being furnished with a lockset including a handle and a latch retractable in response to movement of the handle, the system comprising:
a transmitter associated with the lockset for issuing a wireless signal each time the handle is moved so as to unlatch the door,
a camera arranged to take an image of a user at the door, and
a receiver for receiving the wireless signal from the transmitter and in response thereto triggering the camera to take an image of the user.

16. A surveillance system as defined in claim 15 wherein the lockset includes a switch in circuit with the transmitter, the switch responding to movement of the handle for closing the circuit to operate the transmitter.

17. A surveillance system as defined in claim 15 wherein the lockset includes a latch retractor movable in response to movement of the handle, and a switch in circuit with the transmitter, the switch responding to movement of the latch retractor for closing the circuit to operate the transmitter.

18. A surveillance system as defined in claim 17 wherein the switch is a magnetically responsive switch, and the latch retractor carries a magnet for operating the switch when the latch retractor moves in response to movement of the handle.
